(19) United States
(12) Patent Application Publication
(10) Pub. No.: US 2021/0086465 A1
(43) Pub. Date: Mar. 25, 2021

(54) CASING FOR A ROTOR OF A TABLETING MACHINE

(71) Applicant: Korsch AG, Berlin (DE)

(72) Inventors: Stephan Mies, Berlin (DE); Thomas Weissbach, Berlin (DE)

(21) Appl. No.: 16/635,367

(22) PCT Filed: Jun. 22, 2018
(86) PCT No.: PCT/EP2018/066726

§ 371 Date: Jan. 30, 2020

(30) Foreign Application Priority Data
Aug. 4, 2017 (EP) 17184865.8

(51) Int. Cl. B30B 11/08; B30B 15/00

(52) U.S. Cl. CPC B30B 11/08; B30B 11/34; B30B 15/0082

(57) ABSTRACT

A casing for a rotor of a tableting machine is disclosed. A method for removing excess tableting material from a tableting machine is also disclosed.

The invention relates to a casing for a rotor of a tableting machine. In a further aspect, the invention relates to a method for removing excess tableting material from a tableting machine.

### GENERAL BACKGROUND AND PRIOR ART

Tableting machines are used in many branches of industry to compress powdered or granulated materials into solid compressed pellets. In the pharmaceuticals industry, this may involve numerous forms of tablets, in the chemicals industry it may be dishwashing detergent tablets, toilet cleaner tablets, fertilizer sticks or catalysts, and in the foods industry it may be peppermint tablets or glucose tablets, for example. The sub-class of rotary presses was developed primarily for producing solid and stable compressed pellets in large quantities from powdery or granulated compression materials that are dry, pourable, and free-flowing, within extremely narrow weight tolerances.

For the purposes of the invention, this material for compression is preferably also referred to as tableting material or compression material. As is known from the prior art, when tableting material is compressed to form pellets, dust can form, i.e., undesired particles move around in the compression chamber of the tableting machine and become deposited on internal surfaces of the compression chamber of the tableting machine and/or penetrate into operative areas of the tableting machine where they can impact operation of the tableting machine or can adversely affect the service life of the tableting machine.

Dust Creation—Material Infeed:

The material for compression is delivered to the tableting machine in drums, big bags, or containers, for example, and is placed above the head of the tableting machine. Once the container has been connected to the material feeding system of the tableting press, a slide gate is opened, and the material for compression flows downward by the force of gravity through a vertical feed pipe and into the filling device in the compression chamber of the press. In the context of the invention, the term “compression chamber” preferably refers to the part of the tableting machine in which the compression process is carried out to produce the compressed pellets. The line of material supply from the container to the filling device is generally designed such that all the coupling points are equipped with seals, so that no leakage occurs along this line.

Filling Devices:

There are two types of filling devices for rotary presses, namely gravity filling devices, preferably also referred to as chamber filling shoes in the context of the invention, and motorized filling devices. The use of chamber filling devices preferably presupposes that the material for compression has very good flow and filling properties in order to achieve good tableting results. Since these filling devices do not use motorized aids to improve the filling properties, this is the most gentle method of conveying the material for compression into the die bore without the structure of the powder or the granulate, i.e., the tableting material, being destroyed by excessive friction and movement.

The disadvantage of gravity filling devices is that material for compression that has been metered out cannot be returned to the filling device by the device itself. As a result, compression material is frequently undesirably found on the die table, and the corresponding grains or the powder may be thrown outward by centrifugal force, especially when the rotor of the tableting machine is rotating at high speeds, and may accumulate as waste within the machine. Today, primarily motorized filling devices with filling chambers and impellers are used for tableting machines.

Creation of Dust in the Tableting Machine, Especially in Rotary Presses:

As a rule, tableting material is fed dust-free to the filling device via the material feed system. With a gravity filling device, the compression material is preferably present on the die table over the entire inner surface of the frame, and the material can be moved from left to right through the frame as the die table rotates counterclockwise, for example. The frame of the filling device generally has no seals on its underside and hangs in place, for example, 0.2 mm above the die table. The compression material, which preferably exits on the right-hand side, is guided into the material return channel by the resilient scraper, where it remains until it is lifted out of the channel by a spoon-like scraper on the left side of the filling device and is returned to the inside of the frame of the chamber filling shoe via resilient guide plates.

With motorized filling devices, the filling chamber, in which one or both of the filling and metering wheels are located, is preferably closed except for the fill opening above the die segment. In this case, the material for compression preferably comes in contact with the rotating die table only via the fill opening. In this case too, the so-called filling shoe plates hang in place, for example, approximately 0.1-0.2 mm above the die table. The die table draws the fine powder particles beneath the filling shoe plate through this gap, so that in this case too, a resilient scraper is required to guide the escaping material into the material collecting channel, as otherwise the material loss would be too great.

Conventional rotary presses operate at high rotor speeds that can range from approximately 100 to 120 per minute. Then when compression material exits the filling devices and remains on the die table, this material is forcibly thrown outward on the die table by the tremendous centrifugal force and can fall into the compression chamber of the tableting machine in an uncontrolled manner.

The compression tools themselves are another source of material losses. The lower punch is preferably guided from the filling position to the compression position to the ejection position in the stationary die bore of the die. For this to be possible without the punch becoming jammed in the bore as a result of friction, the diameter of the lower punch and the upper punch is approximately 0.2 mm smaller than the bore diameter of the die. This creates a gap between the lower punch and the die bore, so that very fine particles of the compression material can fall through this gap and down onto the lower part of the rotor. Tableting material thus accumulates undesirably beneath the die table, and is forced outward by the centrifugal forces and can reach the lower cam track and the compression rollers. This soiling is undesirable because it decreases the service life and thus the productivity of the rotary press and increases wear and tear on the mechanical components.

Another critical source of dust in the tableting machine is the area in which the upper punches descend into the filled dies to the right of the filling device. To prevent a spontaneous puffing-out of the compression material when the upper punches descend into a flush-filled die, in modern rotary presses the lower punches are drawn downward by approx. 2-3 mm before the upper punches are inserted, which likewise lowers the compression material by this amount. The upper punches can then descend 2-3 mm into the die before they come into contact with the compression material. Only then are the upper and lower punches moved toward one another by the cams or the compression rollers, thereby advantageously removing air from the loose compression material. The upper and lower punches are preferably located in the cylindrical part of the die bore, but disadvantageously do not completely trap the compression material in the die bore, since the diameter of the upper and lower punches is 0.2 mm smaller than the diameters of the die bores. As a result, the air trapped in the compression material disadvantageously escapes upward and downward through this gap at very high speeds. As a result of this considerable flow of air, the very fine particles in the vicinity of the gap, which are preferably smaller than 0.1 mm, are entrained and thus make their way into the area above and below the die table, which leads to further soiling of the rotary press. These fine airborne particles are particularly hazardous because they can work their way into the punch guides and thereby significantly reduce the service life and thus the productivity of the rotary press.

To minimize material losses of the filling devices, it is known in the prior art to equip filling shoe plates with replaceable resilient seals, enabling a reduction in material losses from the previous (filling devices without a seal) 1.5 to 4% to only 0.4-0.6% (filling devices with a seal) today. For a further reduction in the loss of material, an intermediate base is provided in tableting machines in the region of the lower punch guide of the rotor, separating the lower mechanical region from the upper compression zone and simultaneously sealing it. Above the intermediate base, two to three stationary extraction nozzles can be provided, which are configured to dispose of the settling dust. Since the nozzles are usually positioned individually, spaces in which undesirable dust can further accumulate are created between the nozzles.

To prevent compression dust from penetrating into the lower cam track, it is further known in the prior art to preferably fully encase the lower cam track. In addition, two to three preferably stationary extraction nozzles, for example, are installed in the area around the die table to dispose of the compression dust that is created. Due to the large spaces between the extraction nozzles, however, soiling of the rotary press cannot be effectively prevented despite the suction.

US 2012/0135100, for example, describes a device that has a conveyor unit for tablets, with which tablets can be conveyed from a region around the die table and out of the compression chamber. US 2003/0042639 describes a rotary tableting press that has an enclosed rotor, along with a method for cleaning such a press.

The object of the present invention is to provide a device and a method for removing excess tableting material from a tableting machine that do not have the disadvantages and deficiencies of the prior art and with which undesirable dust and undesired compression material can be removed particularly effectively and with the least possible material losses from all areas of the compression chamber of a tableting machine; it would further be desirable for the device to function with a minimum requirement in terms of hoses and/or tubes and with low suction output to achieve particularly effective, dynamic dust removal.

### DESCRIPTION OF THE INVENTION

The object is attained by the features of the independent claims. Advantageous embodiments of the invention are described in the dependent claims. According to the invention, a casing is provided for a rotor of a tableting machine, the casing comprising at least one integrated annular channel, and the casing further comprising suction means with which a rotating air flow can be generated in the at least one annular channel that is adapted to entrain substantially all of the excess tableting material and remove it from a compression chamber of the tableting machine.

In a preferred embodiment, the invention relates to a device for removing excess tableting material from a compression chamber of a tableting machine, in which compressed pellets are produced in the compression chamber by bringing upper punches and lower punches together in openings in a die table, the die table being held by a rotor. The device is characterized in that the rotor comprises a casing in which at least one annular channel is integrated, and the casing further comprises suction means with which a rotating air flow can be generated in the at least one annular channel that is adapted to entrain substantially all of the excess tableting material and remove it from the compression chamber. In the context of the invention, the terms “device” and “casing” are preferably used synonymously.

Quite surprisingly, the proposed device can be used to generate an air flow within the compression chamber of the tableting machine, which air flow preferably moves in the annular channel and is suitable for entraining the excess tableting material and removing it from the compression chamber. In the context of the invention, the rotating air flow is also preferably referred to as a cyclone, and the proposed device can further preferably be used to create a cyclone with surprisingly low flow losses. Thus, in addition to dynamic dust removal, the device surprisingly enables the creation and provision of a vacuum in the area around the rotor of the tableting machine without the need for additional hoses or tubes.

The term “substantially” in reference to the preferably complete entrainment of the particles and dust particles is not unclear to a person skilled in the art, because a person skilled in the art will know that as a result of the rotating air flow, considerable forces act on the particles and/or dust particles, so that they are completely or nearly completely entrained by the air flow in the at least one annular channel. In some situations, individual particles may not be removed from the compression chamber by the air flow, for example due to their size or because they have become wet causing them to adhere to an inner surface, however such a leaving of particles is undesirable and limited to a few exceptions.

In one embodiment of the invention, the suction means are preferably formed by at least one extraction port, intake nozzles, and/or intake slots. In the context of the invention, the intake connection can preferably also be referred to as an intake nozzle. With the suction means, air can be suctioned particularly effectively out of the compression chamber of the tableting machine, with the suction preferably forming the cyclone in the at least one annular channel of the rotor casing, i.e., an air flow that rotates within the at least one annular channel, i.e., moves there in a circle. In the context of the invention, the annular channel is described as a closed annular channel or flow channel, since it comprises only openings in the areas of the suction means. In the context of the invention, the annular channel preferably has a preferably elliptical and particularly preferably circular footprint, with the annular channel preferably being integrated into the substantially cylindrical rotor casing so that the annular channel is preferably configured as ring-shaped. In the context of the invention, the annular channel preferably has branch points to the preferably separate extraction points of the annular channel, wherein the extraction points are preferably also referred to as intake nozzles in the context of the invention.

At these branch points, a Venturi effect is advantageously created, which further increases the negative pressure present in the annular channel due to the air flow, as a result of which the suctioning effect on the undesired particles and particulates contained in the air flow can be increased a surprising amount and the complexity relating to the attachment of hoses and tubes surprisingly reduced. Hoses and tubes disadvantageously are often associated with undesirable flow resistance and thus with performance losses, and therefore their avoidance and/or reduction is an essential merit of the invention.

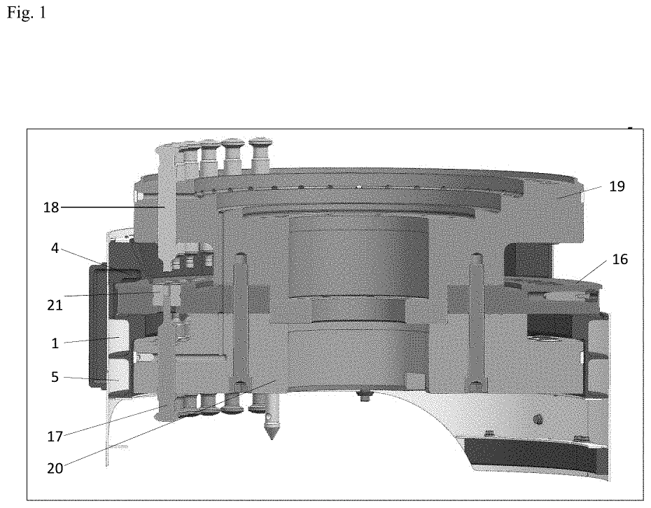

In one embodiment of the invention, the casing is preferably segmented. In the context of the invention, this means preferably that the casing is composed of multiple casing segments, with the casing as a whole preferably having a circular footprint and preferably being formed substantially by an outer wall of a cylinder. The segments of the rotor casing thus preferably correspond to sub-regions of this cylinder outer wall that correspond to one another. In the context of the invention, the rotor preferably comprises a rotor upper part and a rotor lower part, with the die table preferably being arranged between the two components of the rotor. The casing preferably substantially encloses a rotor area comprising the die table and the lower part of the rotor (cf., FIG. 1), the casing having an inner wall that faces the rotor and the compression chamber of the tableting machine, while an outer wall of the casing preferably faces the housing of the tableting machine. In the context of the invention, the term “compression chamber” preferably refers to the area of the tableting machine in which the compression process is carried out to produce the compressed pellets, i.e., preferably the interior of the rotor casing.

In one embodiment of the invention, the suction means are preferably formed by at least one extraction port, intake nozzles, and/or intake slots. Furthermore preferably, the at least one extraction port opens into the casing substantially tangentially to an outer peripheral surface of the rotor. A person skilled in the art will know that a tangent to a point on a circle is at right angles to the radius between the center of the circle and the point on the circle. In the present case, the circle is formed by the preferably annular rotor casing, into which the intake port opens substantially tangentially. The term “substantially” is not unclear to a person skilled in the art, since he will know that this refers to deviations in the single-digit range from the right angle between the intake port and the imaginary radius of the rotor casing.

The device comprises at least one annular channel, although it may also be preferable for other applications for the device, in particular the rotor casing, to comprise multiple annular channels. In other words, it may be preferable for the device to comprise two or more annular channels, which can be arranged, for example, one above the other in the casing. In one embodiment of the invention, it is particularly preferable for an extraction port to be assigned to each annular channel. In other words, it is preferable for each annular channel to have its own tangentially arranged extraction port. Particularly for the production of two-layer tablets, it is preferred for the device, in particular the rotor casing, to comprise two annular channels, in which case the two annular channels, which are preferably separate from one another, can be arranged one above the other. Quite unexpectedly, in the production of two-layer tablets the two annular channels enable an effective separation of the two compression materials from one another, especially when two dust extraction systems are used. The number of annular channels can preferably be adapted to the number of different tableting materials to be compressed.

Unexpectedly, the second and each additional annular channel increases the extraction power to an unexpected and, in particular, disproportional extent. The air flow preferably creates a negative pressure in the compression chamber, which is also referred to as vacuum in the context of the invention. The negative pressure is preferably increased by the presence of constrictions in the annular channel in the areas of the intake nozzles that belong to the suction means. At these constrictions, Venturi effects occur with which the extraction performance of the intake nozzles can be increased considerably. The Venturi effect is based essentially on the fact that the flow velocity of a fluid, for example a liquid or a gas, increases in the area of constrictions in a pipe or a channel. As a result, the pressure at this constriction point drops, advantageously creating a negative pressure with which a suctioning effect in the direction of surrounding areas can be brought about. In one embodiment of the invention, the intake nozzles can preferably be pressurized with negative pressure, in which case it is further preferred for the device to be configured to generate the negative pressure using a Venturi effect.

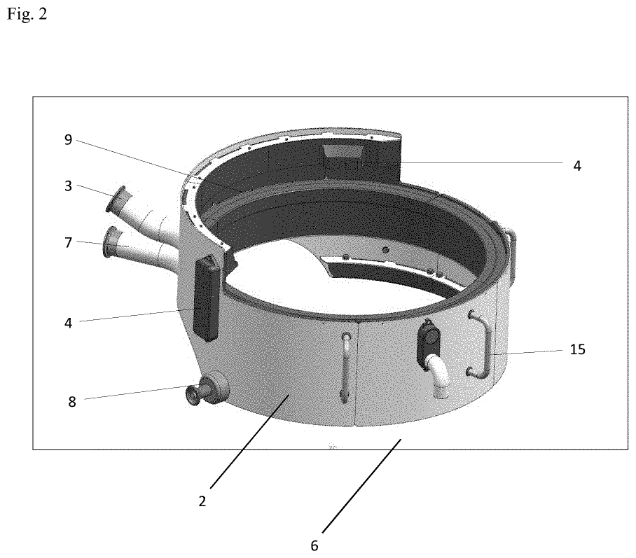

In a further embodiment of the invention, the intake slots are preferably arranged on the inside of the casing at any height, pointing toward the rotor. It is preferable in particular for the intake slots to be arranged at any height on the inside of the casing, pointing toward the rotor upper part, the die table, and/or the rotor lower part, or for the intake slots to be provided on an inner wall of the rotor casing that preferably faces the rotor. The arrangement of the various possible suction means is shown in particular in FIG. 2. The intake slots are preferably slit-shaped, a slit in the context of the invention being an elongated opening in the walls that form the at least one annular channel. Said slots are present in particular in the inner wall of the annular channel, i.e., preferably in the wall of the rotor casing, which faces the rotor.

In one exemplary embodiment of the invention, it is therefore preferred that in particular the rotor lower part and the area around the die table are surrounded by the segmented casing. The at least one closed annular channel is preferably integrated into the rotor casing and comprises a tangentially attached extraction port, the casing having various intake slots at any height on its inside in the direction of the rotor upper part, the die table, and the rotor lower part, for removing excess compression material. Advantageously, the extraction device, which is preferably formed by extraction means and a vacuum cleaning system, creates a strong, dynamic rotating air flow in the annular channel, which is supplied with contaminated air through the intake slots and the preferably partially positioned nozzles.

The central element of the extraction device is preferably the closed, annular air channel, which is integrated into the segmented rotor casing of a rotary press and comprises one or more tangentially arranged intake ports. When combined with a corresponding extraction device, a rotating cyclone that has surprisingly low flow losses is formed in the annular channel. In addition to dynamic dust removal, the proposed device advantageously makes vacuum pressure available for local extraction points over the entire circumference of the rotor, without the need for additional hoses or tubes. Furthermore, at branch points to the separate extraction points an additional Venturi effect is generated, which further increases the negative pressure present in the annular channel, as a result of which the suctioning effect of the proposed device is increased substantially and to a surprising extent.

In a further aspect, the invention relates to a method for removing excess tableting material from a compression chamber of a tableting machine, wherein in the compression chamber, a rotating air flow is generated by suction means, which is adapted to entrain substantially all of the excess tableting material and remove it from the compression chamber. In one embodiment of the invention, the method preferably comprises the following steps:
a) providing a tableting machine having a proposed casing,
b) generating a rotating air flow in an annular channel of a rotor casing,
c) entraining undesired particles by means of the air flow,
d) removing the undesired particles from a compression chamber of the tableting machine by means of at least one intake port.

The definitions, technical effects, and advantages described in reference to the proposed device apply similarly to the method for removing excess tableting material from a compression chamber of a tableting machine.

In particular, the proposed device and the proposed method enable the interior of a tableting machine to be freed very efficiently of the compression dust that is produced, in particular with relatively low extraction power applied extremely effectively. For this purpose, the lower cam track is preferably provided with a full circumferential segmented casing in which, depending on the embodiment, one or more annular channels can be integrated, arranged one above the other. Each channel is preferably provided with its own substantially tangentially attached extraction port, which is in turn connected to an extraction device. The central element of the suction device forms a closed, annular air channel around the rotor, with one or more tangentially arranged intake nozzles, preferably also referred to as intake ports. A rotating air flow (cyclone) is advantageously generated in the annular channel as a result, with a minimal loss of flow. In addition to dynamic dust separation, the device ensures the availability of a vacuum for the intake nozzles, which can preferably be arranged distributed over the entire outer periphery of the rotor, with no further additional feed lines being required. It was completely unexpected that the provision of the intake nozzles allows a Venturi effect to be produced, which significantly increases the extraction performance of the proposed device.

The individual segments of the casing are largely closed from the outside. On the inside of the segments toward the rotor, various intake slots are located on the suction channels, which can be arranged at different heights as required. In the context of the invention, the incoming air required by the cyclone can preferably flow into the annular channel through the intake slots. Since the flow channels are preferably very smooth and without flow obstacles, high flow velocities are achieved in these channels, which in turn causes the incoming air to enter the inflow openings, i.e., the intake slots, at high speed. This in turn causes the compression material particles that are in the air upstream of the compression roller or those that fall under centrifugal force from the die table into the tableting machine to be caught by the air flow and conveyed into the annular channel. The inner inflow openings, i.e., the intake slots, can be located over the entire circumference of the segmented casing, so that optimal dedusting of the rotary press is achieved. Since all of the airborne particles that were previously present in the tableting machine are preferably disposed of by the proposed device and the proposed method, there are no longer any particles in the air of the interior of the tableting machine, and therefore no more dust particles can settle on the inside of the safety window through which the interior of the tablet machine is visible. As a result, excellent monitoring of the production process remains possible throughout the production period of the tableting machine, since the view through the windows is not impeded by unwanted dust particles and excess tableting material. In conventional tableting machines with traditional dust extraction, after about 30-60 minutes the windows are so covered with dust that they no longer have any transparency.

Another advantage of the proposed device and the method is that the flow losses of the rotating air flow are surprisingly low, i.e., are greatly minimized. The proposed device and the proposed method enable dynamic dust removal and represent a simplification of the extraction system in that the complexity with respect to the attachment of tubes and hoses can be significantly reduced by utilizing the Venturi effect and the negative pressure created by the air flow, since there is no further need for application of negative pressure via tubes or hoses. In the context of the invention, the Venturi effect preferably occurs in particular at the branch points.

The extraction system can be configured as particularly flexible, especially in the two-track embodiment of the invention. In the context of the invention, the concept of the two-track embodiment of the invention preferably describes the provision of two annular channels in the rotor casing of the tableting machine. The proposed device and the proposed method make a vacuum available in the region of the intake nozzles of the annular channel and unexpectedly ensure provision of the same, wherein the intake nozzles also unexpectedly function without additional feed lines. In the tableting of two-layer or multi-layer tablets, with the multi-channel embodiment it is surprisingly possible to separate the extraction of individual compression materials, thereby reliably preventing the compression material from being carried off In the context of the invention, the term “multi-channel embodiment” preferably describes the provision of more than one annular channel, wherein the annular channel in the context of the invention is preferably also referred to as a flow channel. If separate dedusting devices, i.e., preferably vacuum cleaning systems, are used for each of the annular channels in the multi-channel embodiment, the different compression materials can also be disposed of in a sorted manner, which represents a further advantage of the invention. Due to the rotating air in the annular channel and the minimal flow losses, the result of extraction around the entire rotor is substantially better than with the conventional extraction systems used in rotary presses, and particularly surprisingly, this improved extraction result is achieved with a significantly lower suction power, for example in the range of 50% of conventional systems.

The invention will be described in greater detail in reference to the attached set of figures; shown are:

FIG. 1 a depiction of a preferred embodiment of the invention, in particular a view of the rotor of a rotary press having a number of rotor casing segments with the integrated annular channel

FIG. 2 a depiction of a preferred embodiment of the invention, in particular a view of a segmented rotor casing having an integrated annular channel with a tangential port for exhaust air

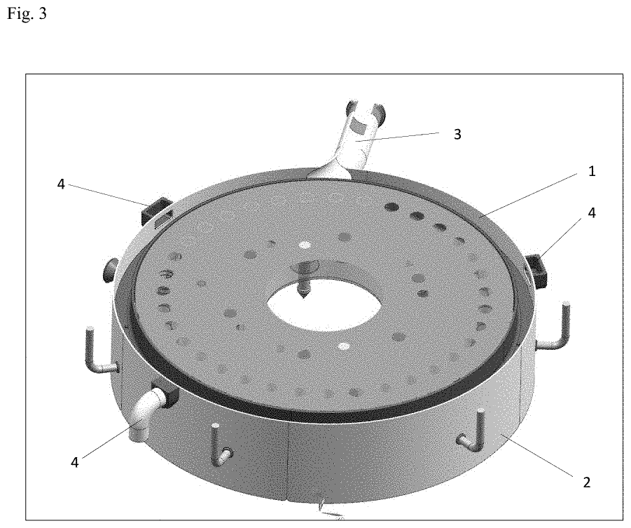

FIG. 3 a depiction of a preferred embodiment of the invention, in particular a view of a complete segmented rotor casing with two integrated annular channels with the two tangentially arranged ports for the exhaust air of the two independent annular channels.

FIG. 1 shows the rotor (22) of a tableting machine comprising a rotor upper part (19) with an upper punch (18), a die table (16) with dies (21), and a rotor lower part (20) with a lower punch (17). The segmented rotor casing (2) with the integrated annular channel (1) is positioned around the rotor (22). The individually positioned extraction nozzles (4) are attached to the corresponding segment for plug-type connection from the outside. The extraction port (3) is attached substantially tangentially to the annular channel (1) and opens substantially tangentially into the same. A second annular channel (5) is located below the first upper annular channel (1).

FIG. 2 shows a segmented, closed rotor casing (2) into which two annular channels (1 and 5, not shown) are integrated, each of the ring channels (1 and 5) having a tangential extraction port (3 and 7). The casing segments (10, 11, 12, 13 and 14) are detachably fastened with quick-release fasteners (8) to the lower cam track (not shown) of the tableting machine. The handles (15) are used for removing the segments (10, 11, 12, 13 and 14). On the interior side of the segments, the intake slots (9) are shown, which can be arranged at different heights around the entire rotor.

The extraction nozzle (4) is preferably designed to be detachable, so that the extraction nozzle (4), which is connected to the annular channel (1) according to the Venturi principle, at least partially frees the tableting machine from dust. FIG. 2 shows the preferred closed, smooth construction of the casing (2) with the integrated annular channel (1). A particularly surprising effect of the invention is clear from FIG. 2, namely that apart from the central extraction port (3), the device does not comprise any further connections, hoses, or tubes, even though the settling dust is removed flexibly from the tableting machine at various different points around the rotor (22). Hose connections disadvantageously are often associated with flow resistance and thus with performance losses, and therefore their avoidance and/or reduction is an essential merit of the invention.

FIG. 3 corresponds essentially to FIG. 2, with the device shown having a second integrated independent annular channel (5) with its own tangentially arranged extraction port (7) below the integrated first annular channel (1) with the tangential extraction port (3). The second annular channel (5) can be used as needed to improve the extraction performance of the additional extraction nozzles (4). Furthermore, in the production of two-layer tablets it is surprisingly possible to separate the two different compression materials.

### LIST OF REFERENCE SIGNS

(1) first annular channel
(2) segmented rotor casing
(3) tangential extraction port of the first annular channel
(4) extraction nozzles
(5) second annular channel
(6) device
(7) tangential extraction port of the second annular channel
(8) quick-release fastener
(9) extraction slots
(10) rotor casing (segment)
(11) rotor casing (segment)
(12) rotor casing (segment)
(13) rotor casing (segment)
(14) rotor casing (segment)
(15) handle
(16) die table
(17) lower punch
(18) upper punch
(19) rotor upper part
(20) rotor lower part
(21) die, i.e., bore in the die table
(22) rotor

1-11. (canceled)

12. A casing for a rotor of a tableting machine, comprising:
at least one integrated annular channel; and,
suction means with which a rotating air flow can be generated in the at least one annular channel, said air flow being adapted to entrain substantially all of the excess tableting material and remove it from a compression chamber of the tableting machine.

13. The casing according to claim 12, wherein at least one extraction port is assigned to each annular channel, and the annular channel has branch points to intake nozzles and/or intake slots, which serve as local extraction points for the excess tableting material.

14. The casing according to claim 12, wherein the casing is segmented.

15. The casing according to claim 12, wherein the suction means is formed by at least one extraction port, intake nozzles, and/or intake slots.

16. The casing according to claim 12, wherein the at least one extraction port leads into the casing substantially tangentially to a peripheral surface of the rotor.

17. The casing according to claim 15, wherein an extraction port is assigned to each annular channel.

18. The casing according to claim 15, wherein the intake slots are arranged on the inside of the casing at any height, pointing toward the rotor.

19. The casing according to claim 12, wherein the device comprises at least two annular channels arranged one above the other in the casing of the rotor.

20. The casing according to claim 15, wherein negative pressure can be applied to the intake nozzles.

21. The casing according to claim 12, wherein the device is configured to generate the negative pressure by utilizing the Venturi effect.

22. The casing according to claim 12, wherein, in areas around intake nozzles in the annular channel, constrictions occur, which increase the suctioning power as a result of the Venturi effect.

23. A method for removing excess tableting material from a compression chamber of a tableting machine, comprising:
generating, with a suction, a rotating air flow in the compression chamber;
entraining with the air flow substantially all of the excess tableting material; and,
removing the excess tableting material from the compression chamber.

24. The method according to claim 23, comprising:
providing a tableting machine having a casing, the casing having at least one integrated annular channel, a suction means with which a rotating air flow can be generated in the at least one annular channel, said air flow being adapted to entrain substantially all of the excess tableting material and remove it from a compression chamber of the tableting machine;
generating a rotating air flow in at least one annular channel of a rotor casing
entraining undesired particles by means of the air flow; and
removing the undesired particles from a compression chamber of the tableting machine through at least one intake port.
